(19) United States
(12) Patent Application Publication
(10) Pub. No.: US 2025/0045413 A1
(43) Pub. Date: Feb. 6, 2025

(54) REAL-TIME RISK ASSESSMENT OF CODE CONTRIBUTIONS

(71) Applicant: SAP SE, Walldorf (DE)

(72) Inventors: Merve Sahin, Antibes (FR); Marco Rosa, Biot (FR)

(73) Assignee: SAP SE, Walldorf (DE)

(21) Appl. No.: 18/230,577

(22) Filed: Aug. 4, 2023

(51) Int. Cl. G06F 21/57; G06F 21/56

(52) U.S. Cl. CPC G06F 21/577; G06F 21/563

(57) ABSTRACT

Contribution requests to a code repository are analyzed with a machine learning model before publishing. The machine learning model can be trained with past metadata of the contributor. Metadata can be extracted from the requests to determine whether the request is atypical for the contributor via a risk score. Requests determined to be atypical can be flagged for action by a security manager. Realtime assessment of code contributions can increase overall software security in a software development context.

### FIELD

The field generally relates to software security in a software development context.

### BACKGROUND

Open-source platforms provide a significant trove of programming code for use by developers, who can simply reuse the software or contribute to the effort. Skillful developers from around the world can contribute bug fixes, documentation, and development of new features. However, there are risks associated with open-source code, especially because the origin of such code is not always clear.

### BRIEF DESCRIPTION OF THE DRAWINGS

FIG. 1 is a block diagram of an example system implementing real-time risk assessment of code contributions.

FIG. 2 is a flowchart of an example method of implementing real-time risk assessment of code contributions.

FIG. 3 is a block diagram of an internal representation of an example request to publish a new code contribution comprising metadata.

FIG. 4 is a flowchart of an example detailed method of real-time risk assessment of code contributions.

FIG. 5 is a screen shot of an example user interface implementing real-time risk assessment of code contributions.

FIG. 6 is a block diagram of an example scenario flagged for alert.

FIG. 7 is a block diagram of an example computing system in which described embodiments can be implemented.

FIG. 8 is a block diagram of an example cloud computing environment that can be used in conjunction with the technologies described herein.

### DETAILED DESCRIPTION

### Example 1—Overview

Open-source platforms provide a significant trove of programming code for use by developers, who can simply reuse software found on the platform or contribute to the effort. Contributions include bug fixes, documentation, and development of new features. However, there are risks associated with open-source code, especially because the origin of such code is not always clear. It is possible that a developer may have a malicious intent, or the developer's account may be compromised. In such cases, a threat actor may try to integrate malicious code into the project within the scope of a code contribution.

Various tools can be used to scan source code contributions to prevent vulnerabilities from being introduced in existing software, but it is difficult to verify the identity of the contributors and the legitimacy of their contributions without taking the time to access and scan their source code. As noted, a threat actor could take over the account of an existing user and impersonate the user, publishing a malicious source code contribution under someone else's name.

An automated solution as described herein can verify the legitimacy of contributions without (e.g., before) scanning content for vulnerabilities with traditional scanners. Such technologies can be used to warn a security manager of contributions that have a high risk and should therefore receive increased scrutiny. If desired, the described technologies can work in concert with traditional scanners.

The technologies can thus usefully warn the security manager of a contribution showing a high risk score that should receive higher attention. Such automation can helpfully reduce the number of requested approvals to only those warranting further scrutiny.

The technologies can thus assess the risk of a code contribution in real-time and notify the security manager before a high-risk contribution is accepted.

As described herein, the technologies can determine a risk score for a source code contribution based on the metadata of the contribution request and the historical data collected from past contributions (e.g., by the same purported contributor). Metadata can be extracted from a request to publish a new code contribution to obtain a variety of features that can be input to a machine learning model that outputs a risk score as described herein. A risk disposition can be determined, and the request can be processed accordingly.

Other techniques such as notifying a developer via a second communication channel when a request is rejected can be implemented as described herein.

The described technologies thus offer considerable improvements over conventional code assessment techniques.

### Example 2—Example System Implementing Real-Time Risk Assessment of Code Contributions

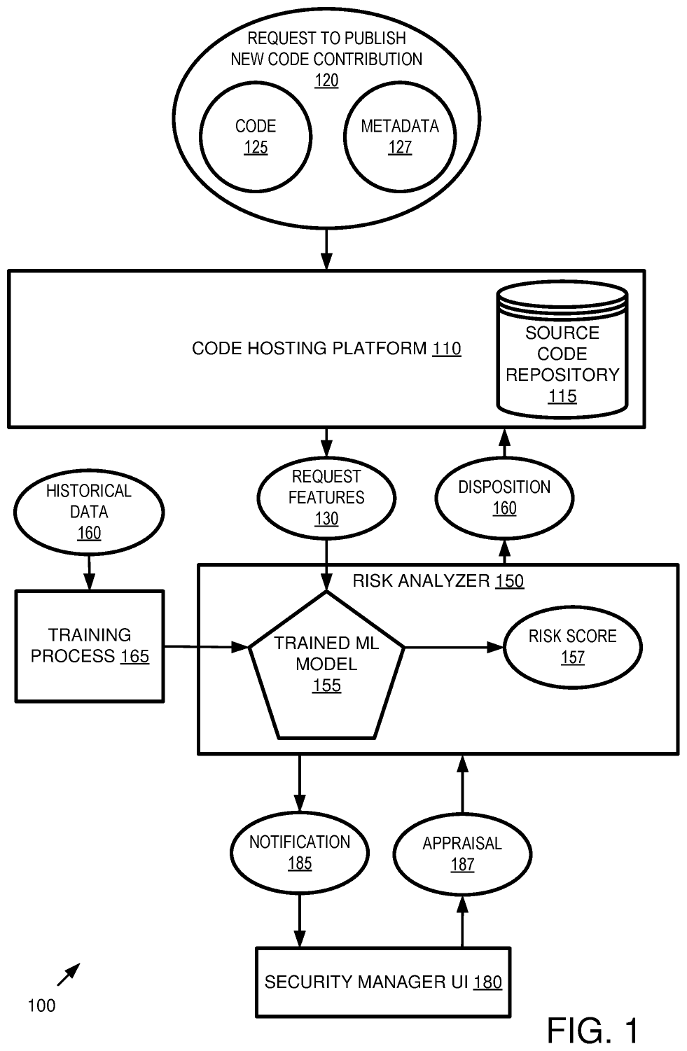

FIG. 1 is a block diagram of an example system 100 implementing real-time risk assessment of code contributions. In the example, the system 100 can include a code hosting platform 110 comprising a source code repository 115 of published code contributions. The technologies described herein can be used with a variety of code hosting platforms, including conventional platforms, and the code hosting platform 110 is an example. The platform 110 can be administered by a different actor than the risk analyzer 150, even if the two work together to accomplish security. As described herein, the platform 110 can be public or private. The platform 110 can be on premise or in the cloud.

As shown, the code hosting platform 110 can be configured to receive a request 120 from a purported contributor to publish a new code contribution that comprises both code 125 and associated metadata 127. In practice, a user creates an account and eventually requests that new code contributions be added to the code repository.

The platform 110 can be configured to receive features 130 of the request, which can take the form of extracted metadata or the request 120 itself, and send to the risk analyzer 150.

The risk analyzer 150 is configured to receive the features 130 and apply the features 130 to a trained machine learning model 155, which outputs a risk score 157 based on the input features of the request. Although the features 130 are shown as being sent from the platform 110 to the risk analyzer 150, the risk analyzer 150 can comprise a metadata collector (not shown) that can extract features from a conventional code hosting platform (e.g., by scraping or crawling metadata available on the platform about contributions, deriving further metadata, or the like). For example, an indication of the request 120 can be sent to the risk analyzer 150 instead of sending the actual request 120. Some metadata can be related to the contribution source code (e.g., number of files, programming language, lines of code added, or the like), while others are not (e.g., timestamp of the request, IP address of the requester, or the like).

As shown, the trained machine learning model 155 can be trained via a training process 165 that uses historical data 160 about past contributions (e.g., past observed requests to publish new code contributions) to compute a risk score. For example, if the request 120 is made in the name of a given user (e.g., Alice), the model 155 can be trained using request features of past contributions by Alice. The model 155 can be a classification or clustering agent trained on users' historical metadata. It evaluates a new contribution based on the purported contributor's historical metadata and returns a risk score indicating atypicality of the request. The risk score will be higher when the contribution deviates from previous behavior of the same purported contributor.

After the risk score 157 is computed, it can be compared with a threshold configurable by the security manager responsible for the source code project. If the risk score does not meet the threshold, the contribution is considered legitimate. Otherwise, a decision is made by the security manager using a user interface 180. For example, based on the risk score 157, an automated decision can be made as to whether or not to send a notification 185 to a security manager user interface 180, by which a security manager can respond with an appraisal 187 (e.g., whether or not the contribution is approved). The user interface 180 can be configured to present a risk assessment alert to a security manager responsive to detecting that the risk score computed by the machine model for the request exceeds a threshold.

The appraisal 187 can be sent to the risk analyzer or directly to the code hosting platform 110 to indicate whether or not to publish the contribution associated with the request (e.g., the code 125).

Thus, contributions that exceed the threshold can be flagged for further evaluation (e.g., via notification to the security manager user interface 180). Contributions that have an approved appraisal 187 can be used to retrain the model 155. Otherwise, the request 120 is denied, and further actions can be taken as described herein.

Any of the systems herein, including the system 100, can comprise at least one hardware processor and at least one memory coupled to the at least one hardware processor. The system 100 can also comprise one or more non-transitory computer-readable media having stored therein computer-executable instructions that, when executed by the computing system, cause the computing system to perform any of the methods described herein.

In practice, the systems shown herein, such as system 100, can vary in complexity, with additional functionality, more complex components, and the like. For example, the training data 160 can include training data from a large number of users and test data so that predictions can be validated. There can be additional functionality within the training process. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the source code repository 115, request 120, training data 160, trained model 155, and the like can be stored in one or more computer-readable storage media or computer-readable storage devices. The technologies described herein can be generic to the specifics of operating systems or hardware and can be applied in any variety of environments to take advantage of the described features.

### Example 3—Example Method Implementing Real-Time Assessment of Code Contributions

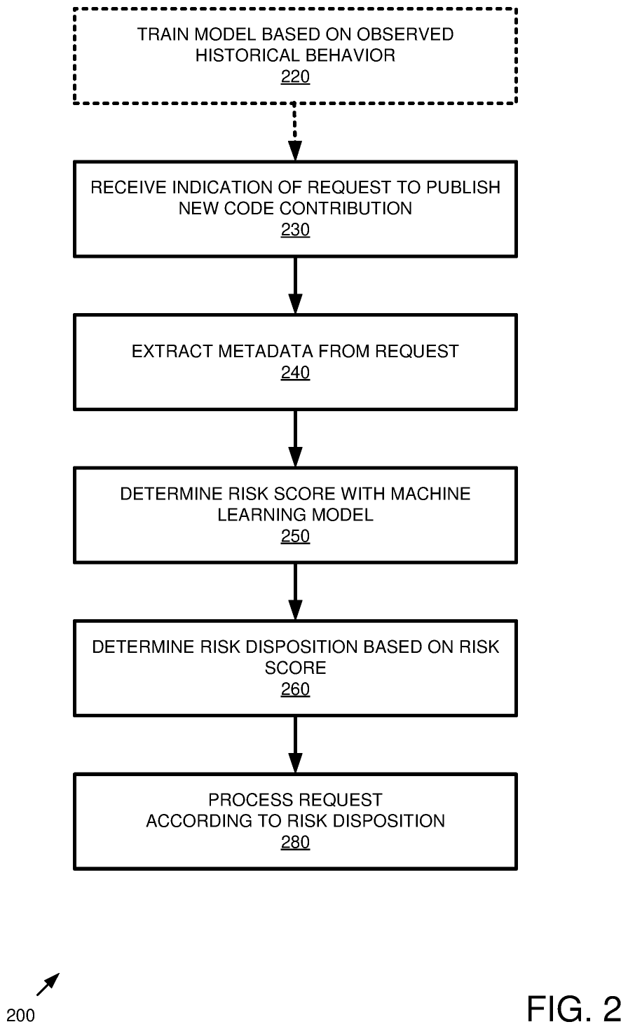

FIG. 2 is a flowchart of an example method 200 of real-time risk assessment of code contributions and can be performed, for example, by the system of FIG. 1. The automated nature of the method 200 can be used in a variety of situations such as assisting in protecting code repositories, identifying suspicious actors, or the like.

In the example, at 220, a machine learning model is trained based on observed historical behavior. Such training can be done in advance of the actual use of the technology (e.g., by another actor, at another location, or at a different time). As described herein, the machine learning model is trained to determine atypical metadata for a purported contributor. A higher score indicates higher atypicality.

At some point, the code repository platform receives, from a purported contributor, a request to publish (e.g., add) a new code contribution to a code repository. At 230, an indication of the request to publish a new code contribution to a code repository is received. As described herein, the request comprises proposed source code and request metadata. The actual request need not be sent to a risk analyzer to trigger processing for risk determination. As described herein, an indication of the request can trigger processing. Such an indication can be sent to the risk analyzer responsive to receiving the request to publish. Although the terminology used can vary, the process typically starts with a commit by the purported contributor, who is requesting that the contribution be published as part of the code repository of a particular project on a code hosting platform. As described herein, actual publication can be blocked until the request is found not to be high risk. Or, if the request is found to be high risk (e.g., flagged), actual publication can be blocked until the request is approved.

At 240, metadata can be extracted from the request. Several features can be collected from the code contribution request as described herein, without inspecting the code content. Any of the example metadata as described herein can be used as features.

The features can then be evaluated by a machine learning model trained on metadata observed in the past (e.g., extracted features from the same purported contributor's past contributions). At 250, a risk score for the new code contribution is determined based on the extracted request metadata. As described herein, determining the risk score comprises submitting the extracted request metadata to the machine learning model (e.g., which has been trained with past metadata of the purported contributor). As described herein, the risk score indicates whether the new code contribution is atypical for the purported contributor. A high risk score indicates anomalous behavior of the contributor (e.g., contributing in a programming language never used before, from a different geographical location than before, or the like).

At 260, a risk disposition of the request is determined based on the risk score. For example, responsive to determining that the risk score exceeds a threshold, a notification can be sent to a security manager user interface. An appraisal can be received in response and used as the risk disposition (e.g., an appraisal indicating whether the contribution is approved for publication as part of the code repository). If the security manager finds abusive or malicious content in the source code contribution, the security manager can reject it and possibly block the user. On the contrary, if the contribution is legitimate and it is accepted, its metadata can be used to update (e.g., retrain) the machine learning model.

At 280, the request is processed according to the risk disposition. For example, if an approved appraisal response is received from the security manager, the new code contribution can be published (e.g., the request is accepted).

As described herein, the new code contribution can be blocked from being added to the source code repository until it is approved.

If the new code contribution is rejected, the contributor can be notified. For example, responsive to receiving a rejection appraisal from a security manager user interface, the purported contributor can be notified via a secondary channel (e.g., a backup user email address, text message, or the like). In this way, the actual author can be informed that the account may be compromised. The account can also be blocked from further contributions until the matter is resolved.

As described herein, the machine learning model can be trained with past metadata from across a plurality of code hosting platforms, projects, or both.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving a request can be described as sending a request depending on perspective.

### Example 4—Example Machine Learning Model

In any of the examples herein, a machine learning model can be used to generate predictions based on training data. In practice, any number of models can be used. Examples of acceptable models include one-class classifier or different clustering techniques that can be used for anomaly detection (e.g., hierarchical, density, or grid-based clustering such as DBSCAN and CLIQUE, or Gaussian mixture models), and the like. The model can be used to check whether the new data point is an outlier (e.g., whether it is atypical for a given purported contributor). Such models are stored in computer-readable media and are executable with input data (e.g., the metadata as described herein) to generate an automated prediction (e.g., the risk score).

In practice, a separate model can be maintained for each contributor. For contributions made by a new contributor (e.g., no model or data yet exists), a default assessment of illegitimate (e.g., high risk) can be used (e.g., code from new contributors is sent for approval to the security manager regardless of the metadata).

### Example 5—Example Real-time Assessment

In any of the examples herein, assessment can be performed in real time. For example, using a machine learning model, the contribution can be evaluated before it is accepted, instead of accepting the contribution and then making a determination for a contribution already accepted. In a real-time scenario, immediate evaluation by the machine learning model is possible, typically under one minute, and often much faster. Thus, a notification can be sent quickly. Ultimate approval of a high risk contribution may take more time to allow for further consideration (e.g., by a human security manager), but the number of notifications for further consideration can be reduced based on accuracy of the machine learning model.

Evaluation can comprise submitting metadata of the request as features to a machine learning model. A threshold can then be used to immediately assess risk of the request. If the machine learning model outputs a risk exceeding the threshold, the contribution is assessed as high risk, warranting further review.

### Example 6—Processing the Request According to Risk Disposition

In any of the examples herein, a risk disposition can be determined, and the request processed accordingly. For example, the request can be immediately flagged as high risk based on the output from the machine learning model (e.g., the risk score exceeds a threshold). Otherwise, the request can be granted (e.g., the risk disposition indicates low risk, so publication takes place).

Flagged requests can undergo further evaluation. For example, a security manager can be notified as described herein. The risk disposition can then take the form of an appraisal received from a security manager user interface as described herein.

Processing can comprise blocking the request while it is pending, obtaining an appraisal, and then processing the request according to the appraisal. An approved appraisal can result in publishing the source code by adding it to the source code repository. In practice, publication can be achieved by changing a status attribute of the contribution from “blocked” or “pending” to “available,” “open,” “published,” or the like.

A rejected appraisal can result in rejecting the request, notifying the contributor, and the like.

### Example 7—Example Risk Score

In any of the examples herein, the trained machine learning model can output a risk score. Such a score can indicate how likely it would be that the contribution is atypical, given input metadata would be assigned to a given header target. When displaying the score, color coding can be used (e.g., using green, yellow, red to indicate high, medium, or low risk scores).

As described herein, the risk score can be used to assess risk and indicate when a new code contribution is risky (e.g., it exceeds a configurable threshold as described herein).

In practice, the risk score can be inverted (e.g., the risk score indicates a level of safety instead of risk).

### Example 8—Example Code Hosting Platforms

In any of the examples herein, any of a variety of code hosting platforms can be used by which developers can collaborate on a software development project that has code stored in a source code repository. Although the technologies can be especially useful in the open-source context, the techniques described herein can also be equally applied to other scenarios, such as private development, commercial development, cross-enterprise development, or the like.

### Example 9—Example Internal Representation of Request to Publish a New Code Contribution Comprising Metadata

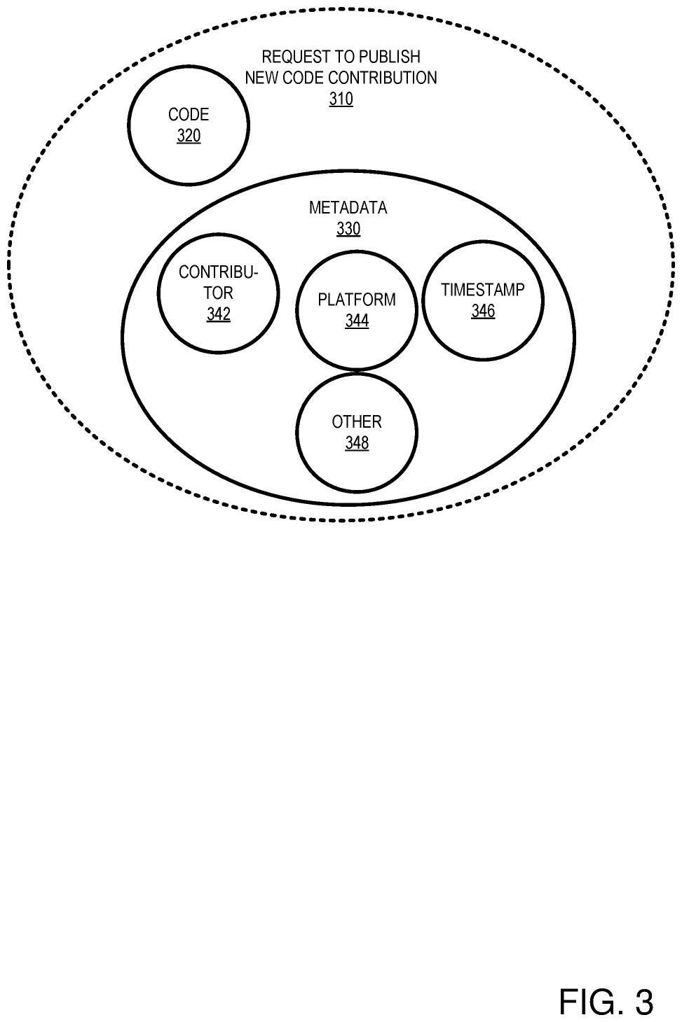

FIG. 3 is a block diagram of an internal representation of an example request 310 to publish a new code contribution comprising both the code itself 320 and metadata 330.

While the code 320 includes the actual source code, the metadata 330 can comprise information about the code 320 or the request 310. Such metadata can include an identifier for the contributor 342, an indication of the platform 344 used to make the request, a timestamp 346 of the request or commit, or other metadata 348. Metadata extraction can include calculating or deriving further metadata based on metadata present in the request (e.g., to determine how long it has been since the contributor last contributed, etc.).

Although a simple identifier for the contributor 342 can be used, in practice there can be plural indications of the contributor (e.g., account name, contributor name, contributor email address, secondary email address, alternate contact information, nickname, screen name, or the like).

In any of the examples herein, a wide variety of metadata can be supported. For example, the size of the contribution (e.g., number of files contributed, number of files removed, number of files modified, number of bytes contributed, number of features affected, or the like), geographical location (e.g., country, region, postal code, city, or the like), IP address used to contribute, whether documentation is present in the request or the code, the programming language of the code 320, the technique used to request the contribution (e.g., a code development environment, website, command line, or the like), code generation tool used, email address, the grammar correctness of any human language description, the human language used (e.g., English, French, Hindi, or the like), the amount of time passed since the last contribution, the platform used for the contribution (e.g., Windows, Macintosh, Linux, or the like), program used to sign the commit, commit artifacts (e.g., file names created, file extensions, or the like), and others can be used.

As described herein, the metadata can be used for assessment without actually using the content of the code 320. For example, metadata about aspects of the code 320 such as size and language (e.g., which can be determined by filename extensions or the like) can be used for assessment without relying on the logic, semantics, execution graph, abstract syntax tree, static analysis, dynamic analysis, or keywords of the code 320.

### Example 10—Example Training Data

Any of the features described herein can be used for training data when training a machine learning model that outputs a risk score. Historical metadata assumed to be legitimate can be labeled as legitimate, or legitimacy can be implied. Metadata can be labeled according to the contributor, separate models constructed for respective contributors, or the like.

Metadata from training can come from a variety of sources. For example, in a public context, metadata may be freely available as part of published contributions. Metadata can be scraped by crawling web pages presented by the project website. Additional metadata from other projects, other sites, or other code hosting platforms can also be incorporated into training for the machine learning model. Thus, the machine learning model can be trained with past metadata across a plurality of code hosting platforms, projects, or both.

In a private context, data can be available on internal websites, or a database of metadata may be available from which metadata can be extracted.

Observed data is sometimes called “historical” because it reflects a past contribution that can be observed and leveraged for training purposes.

### Example 11—Example Detailed Method of Real-Time Risk Assessment of Code Contributions

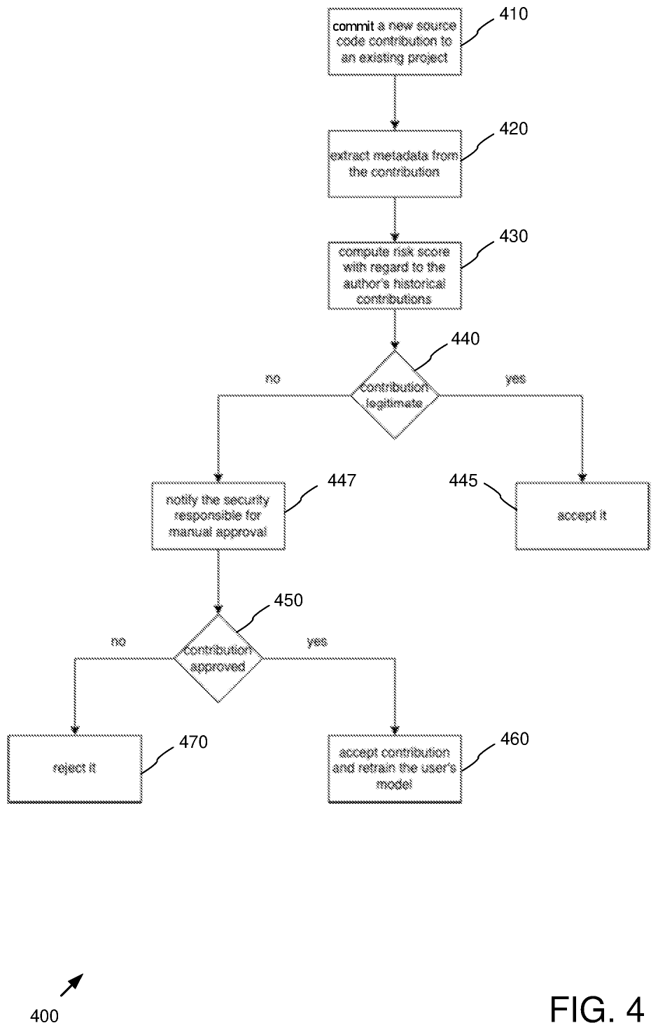

FIG. 4 is a flowchart of an example detailed method 400 of real-time risk assessment of code contributions and can be implemented in any of the examples herein (e.g., the system shown in FIG. 1). The method 400 can be implemented as a more detailed version of the method 200 of FIG. 2.

A developer (a so-called “purported contributor”) wishes to contribute to an existing project whose source code is shared on a code hosting platform. The developer commits the source code, describing that it will fix some existing bug or vulnerability or will offer new features (e.g., possibly requested by other users in the past). At 410, the request to publish a new code contribution to a code repository from the purported author is received. For example, as described, a contributor can perform a commit for code on an existing project.

To avoid vulnerability exposure, it is possible to scan the code before or during publication to reduce the risk of exploitability. While such an approach may be helpful, the method 400 does not focus on scanning the code. The method 400 distinguishes between a legitimate and a malicious/abusive contribution based on the purported contributor's metadata. At 420, metadata is extracted from the contribution (e.g., the request). For example, the number of added, removed, or modified files, the programming language used, the timestamp of the commit, the amount of time passed since the last contribution, or other metadata can be extracted as described herein.

The contribution can thus be evaluated according to historical metadata collected from the same purported contributor. A machine learning model can be used to compute the risk score for the contribution, computing how much the new contribution deviates from the usual behavior of the purported contributor. At 430, a risk score is computed based on the purported contributor's historical contributions. As described herein, such a risk score computation can be determined with a machine learning model to which metadata are applied as input features. Assuming the historical data is composed of legitimate code contributions, a one-class classifier or clustering techniques can be used to model the legitimate behavior and check whether the new data point is an outlier. For example, a one-class support vector machine can implement unsupervised outlier detection. Other models are possible.

After the risk score is computed, it can be compared to a threshold value to decide if the contribution is legitimate (e.g., the contribution is verified), or if it requires more attention from a security manager. The risk threshold can be set by a security manager (e.g., the same or a different person who reviews contributions using traditional scanners). At 440, responsive to determining that the contribution is legitimate (e.g., the score does not meet a threshold), the contribution can be accepted (published) at 445.

Conversely, at 440 if the contribution is found not to be legitimate (e.g., the risk score indicates that the contribution is atypical), the security manager responsible for approval is notified at 447 as described herein. As described herein, a notification can be sent to a security manager user interface. The security manager can then analyze the contribution (e.g., including the code) and determine whether the contribution is approved at 450. If so, the contribution can be accepted at 460. Acceptance comprises publication of the contribution (e.g., it is added to the code repository or otherwise designated as published). The acceptance can then be used to retrain the model (e.g., an overall model or a model for the purported contributor), resulting in a more accurate model.

Conversely, if the contribution is not approved, at 470 the contribution is rejected.

After the contribution is accepted or rejected, the contributor can be notified. In the case of a rejected contribution, as secondary channel can be used.

In practice, the contribution can be blocked from publication until it is approved, either based on the score at 445 or the appraisal at 460.

### Example 12—Example Training Process

In any of the examples herein, training can proceed using a training process that trains the model using available training data. In practice, some of the data can be withheld as test data to be used during model validation. As described herein, different models can be trained for respective purported contributors (e.g., authors).

Such a process typically involves feature selection and iterative application of the training data to a training process particular to the machine learning model. After training, the model can be validated with test data. An overall confidence score for the model can indicate how well the model is performing (e.g., whether it is generalizing well).

In practice, machine learning tasks and processes can be provided by machine learning functionality included in a platform in which the system operates. For example, in a development context, training data can be provided as input, and the embedded machine learning functionality can handle details regarding training.

### Example 13—Example User Interface

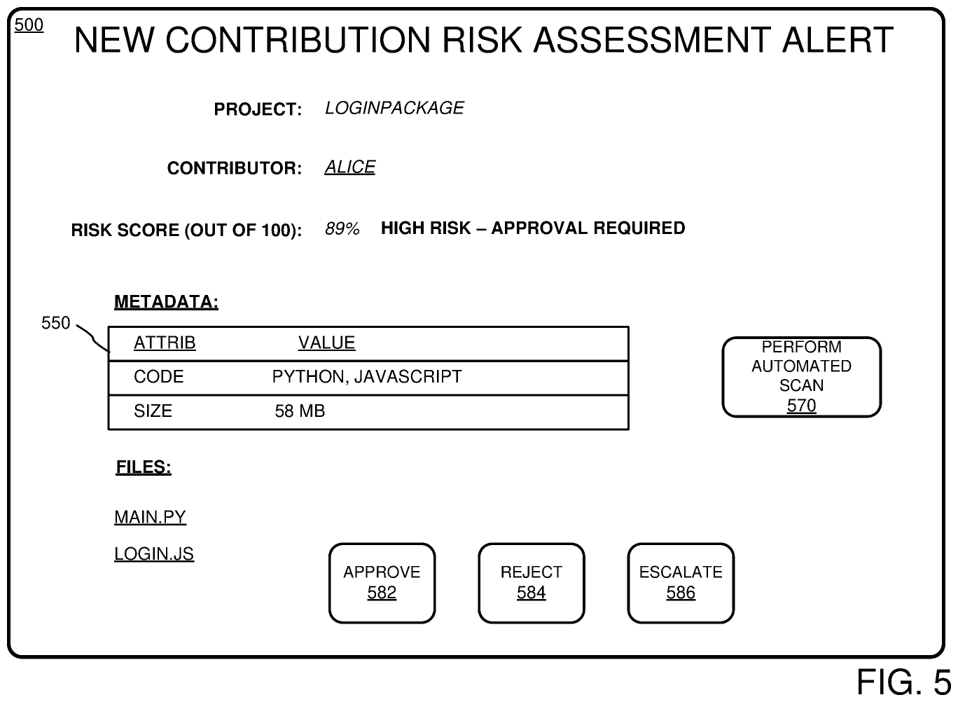

FIG. 5 is a screen shot of an example user interface 500 implementing real-time risk assessment of code contributions that can be used in any of the examples herein. In the example, a request to publish a new code contribution from a purported contributor “Alice” has been assessed as risky, so a notification to a role responsible for security (e.g., a security manager) has been sent, the details of which are shown in the user interface 500.

As shown, the risk score can be displayed along with other details, such as metadata 550, related files (e.g., source code of the contribution), and the like.

Optionally, a user interface element 570 can be activated. Responsive to activation of the element 570, an automated scan with a traditional scanning mechanism can be initiated (e.g., to evaluate the source code of the contribution). Results can then be provided to assist in approval of the request.

Pushbuttons 582, 584, 586 or links can be provided by which the user interface can receive approval or rejection of the request to contribute. Additional options (e.g., to escalate the request, block the user name, notify the contributor via a different channel, or the like) can also be provided. An appraisal response can be sent based on the option selected. For example, an approved appraisal response indicates that the new code contribution can be published. Otherwise, a negative outcome can result in blocking the request and possibly notifying the contributor as described.

Instead of showing a single request, the user interface 500 can show a list of a plurality of requests stored in a queue that can be individually or collectively approved or rejected.

In practice, any of a variety of user interfaces can be used. For example, anything from a full-featured dashboard to a simple text message can be used to approve or reject requests to publish a new code contribution that has been flagged as atypical for the contributor.

### Example 14—Example Scenario Flagged for Alert

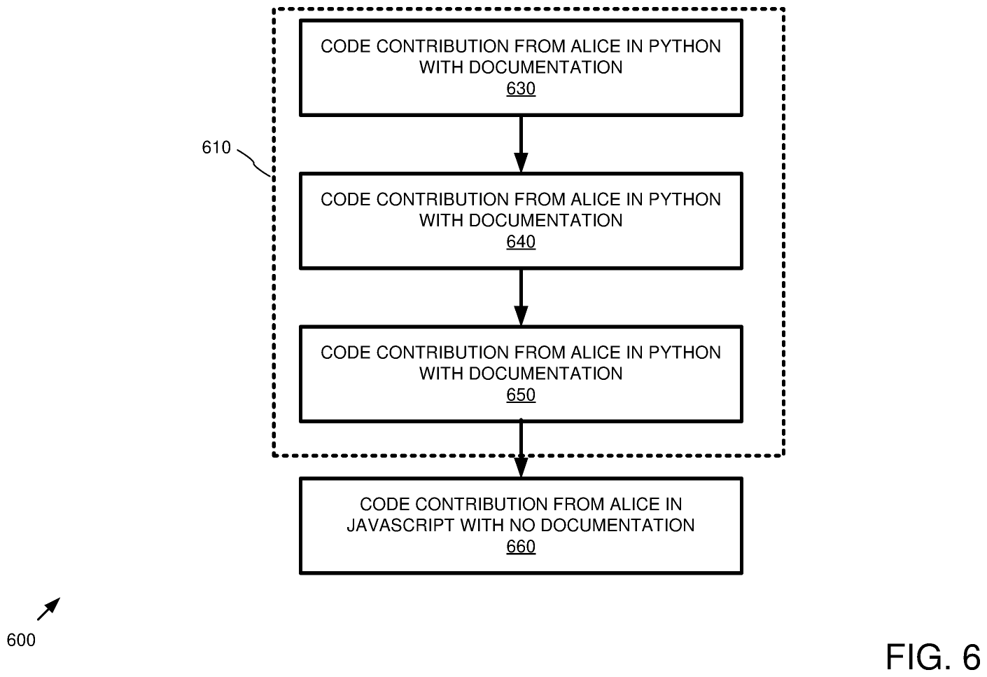

FIG. 6 is a block diagram of an example scenario 600 flagged for alert. In the example, the observed past history 610 for a contributor “Alice” indicates 630, 640, 650 that the user typically contributes using the Python programming language and includes documentation. Such metadata can be used to train a machine learning model that outputs a risk assessment based on whether a new contribution 660 is atypical.

Metadata of the new contribution 660 shows that a request to contribute code in the JavaScript language with no documentation has been received. As described herein, such a request is assigned a higher risk score because it is atypical for the user.

In practice, some histories are more complex and lengthy, but real time assessment can be accomplished via a machine learning model as described herein.

### Example 15—Use Cases

The technologies can be applied in any of a variety of use cases, one of which follows.

The ACME company is responsible for the administration and maintenance of the XYZ component that ACME decided to open source on a public hosting platform. The external user ALICE proposes a new source code contribution to XYZ, justifying it as a new feature requested by the community of XYZ users. ACME is concerned about the risk of introducing bugs and vulnerabilities in an open source component managed directly by them, but ALICE is a long-time contributor known to ACME, and she always provided valuable contributions on XYZ in the past.

ALICE's contribution metadata are collected, and the machine learning model shows a high risk score. The security manager is notified and starts an investigation, observing that ALICE's contribution is written in JavaScript, while she is a well-known Python developer, and that she did not include documentation, which she never forgets to submit. This behavior is atypical for ALICE, and further security scans highlight malicious content voluntarily introduced in the code contribution. ALICE's account has probably been stolen or taken over in a phishing attack, and her contributions can no longer be considered reputable.

### Example 16—Example Implementations

Any of the following can be implemented.

Clause 1. A computer-implemented method comprising:
receiving an indication of a request to publish a new code contribution to a code repository from a purported contributor, wherein the request comprises proposed source code;
extracting request metadata from the request;
determining a risk score for the new code contribution, wherein determining the risk score comprises submitting the extracted request metadata to a machine learning model trained with past metadata of the purported contributor;
determining a risk disposition of the request based on the risk score; and
processing the request according to the risk disposition.

Clause 2. The method of Clause 1, wherein:
determining the risk disposition of the request comprises:
responsive to determining that the risk score exceeds a threshold, sending a notification to a security manager indicating that the new code contribution is determined to be risky;
receiving an appraisal response from the security manager; and
responsive to an approved appraisal response from the security manager, publishing the new code contribution.

Clause 3. The method of Clause 2, wherein:
the new code contribution is blocked from being added to a source code repository until it is approved.

Clause 4. The method of any one of Clauses 1-3, further comprising:
responsive to receiving a rejection appraisal from a security manager user interface, notifying the purported contributor that the request was rejected via a secondary channel.

Clause 5. The method of any one of Clauses 1-4, wherein:
the machine learning model is trained with past metadata from across a plurality of code hosting platforms or projects.

Clause 6. The method of any one of Clauses 1-5, wherein:
the machine learning model is trained to recognize atypical metadata for the purported contributor.

Clause 7. The method of any one of Clauses 1-6, wherein:
the request metadata comprises an IP address of the purported contributor.

Clause 8. The method of any one of Clauses 1-7, wherein:
the request metadata comprises a timestamp of the request to publish the new code contribution to the code repository.

Clause 9. The method of any one of Clauses 1-8, wherein:
the request metadata comprises presence of commit artifacts of the request to publish the new code contribution to the code repository.

Clause 10. The method of any one of Clauses 1-9, wherein:
the request metadata comprises a programming language of the new code contribution.

Clause 11. The method of any one of Clauses 1-10, wherein:
the request metadata comprises a human language of the request to publish the new code contribution to the code repository.

Clause 12. The method of any one of Clauses 1-11, wherein:
the request metadata comprises a number of files of the request to publish the new code contribution to the code repository.

Clause 13. The method of any one of Clauses 1-12, wherein:
the request metadata comprises a size of the new code contribution.

Clause 14. The method of any one of Clauses 1-13, wherein:
the request metadata comprises an amount of documentation of the request to publish the new code contribution to the code repository.

Clause 15. A computing system comprising:
at least one hardware processor;
at least one memory coupled to the at least one hardware processor;
a source code repository of published code contributions;
a machine learning model trained with request metadata of past observed requests to publish new code contributions to the source code repository to compute a risk score; and
one or more non-transitory computer-readable media having stored therein computer-executable instructions that, when executed by the computing system, cause the computing system to perform:
   receiving a request to publish a new code contribution to the source code repository from a purported contributor, wherein the request comprises proposed source code and request metadata;
   extracting the request metadata from the request;
   determining a risk score for the new code contribution, wherein computing the risk score comprises submitting the request metadata to the machine learning model, wherein the machine learning model is trained with past metadata of the purported contributor;
   determining a disposition of the request based on the risk score; and
   processing the request according to the disposition.

Clause 16. The system of Clause 15, further comprising:
a user interface configured to present a risk assessment alert to a security manager responsive to detecting that the risk score computed by the machine learning model for the request to publish the new code contribution exceeds a threshold.

Clause 17. The system of Clause 16, wherein:
the threshold is configurable by the security manager.

Clause 18. The system of any one of Clauses 15-17, wherein:
determining the disposition of the request comprises:
responsive to determining that the risk score exceeds a threshold, sending a notification to a security manager indicating that the new code contribution is determined to be risky;
receiving an appraisal response from the security manager; and
responsive to an approved appraisal response from the security manager, publishing the new code contribution.

Clause 19. The system of any one of Clauses 15-18, wherein:
the machine learning model is trained to recognize atypical metadata for the purported contributor; and
the request metadata comprises:
an IP address of the purported contributor;
a timestamp of the request to publish the new code contribution to the source code repository;
a programming language of the new code contribution;
a human language of the request to publish the new code contribution to the source code repository; and
a size of the new code contribution.

Clause 20. One or more non-transitory computer-readable media comprising computer-executable instructions that, when executed by a computing system, cause the computing system to perform operations comprising:
receiving an indication of a request to publish a new code contribution to a source code repository from a purported contributor, wherein the request comprises proposed source code and request metadata;
extracting the request metadata from the request;
determining a risk score for the new code contribution, wherein computing the risk score comprises submitting the request metadata to a machine learning model trained with past metadata of the purported contributor;
determining a disposition of the request based on the risk score; and
processing the request according to the disposition;
wherein:
determining the disposition of the request comprises:
responsive to determining that the risk score exceeds a threshold, sending a notification to a security manager indicating that the new code contribution is determined to be risky;
receiving an appraisal response from the security manager; and
responsive to an approved appraisal response from the security manager, publishing the new code contribution; and
based on the risk score, the new code contribution is blocked from being added to the source code repository until the new code contribution is approved.

Clause 21. One or more non-transitory computer-readable media comprising computer-executable instructions that, when executed by a computing system, cause the computing system to perform the method of any one of Clauses 1-14.

### Example 17—Example Advantages

A number of advantages can be achieved via the technologies described herein. For example, an end-to-end solution can automate the real-time detection of a suspicious code contribution, together with the notification of a security manager for a feedback mechanism.

Analysis of metadata can take place quickly. So instead of evaluating code after it is published, evaluation can take place beforehand. The automated notification of a security manager can add efficiency to the technologies.

If contributions assessed by the machine learning as suspicious (e.g., high risk) are approved, accuracy of the model can be improved by re-training with metadata as described herein.

Implementing the machine learning technologies in a production environment as described allows development collaboration to continue to take place in most cases, while still flagging potential risks to the code base.

Finally, a well-orchestrated security plan carried out using the technologies described herein, whether with or without conventional source code scanning techniques, can avoid malicious contributions, improving overall security of the project.

### Example 18—Example Computing Systems

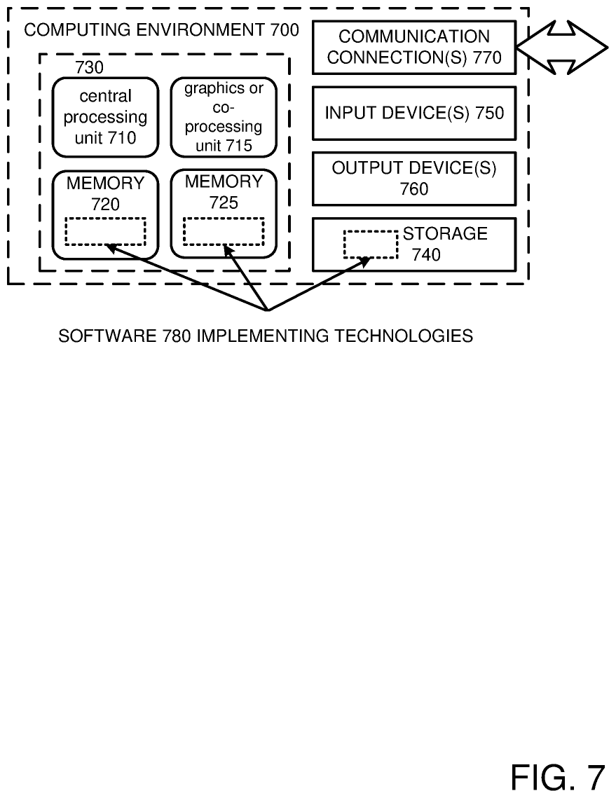

FIG. 7 depicts an example of a suitable computing system 700 in which the described innovations can be implemented. The computing system 700 is not intended to suggest any limitation as to scope of use or functionality of the present disclosure, as the innovations can be implemented in diverse computing systems.

With reference to FIG. 7, the computing system 700 includes one or more processing units 710, 715 and memory 720, 725. In FIG. 7, this basic configuration 730 is included within a dashed line. The processing units 710, 715 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 can be volatile memory (e.g., registers, cache, RAM), non-volatile memory (e.g., ROM, EEPROM, flash memory, etc.), or some combination of the two, accessible by the processing unit(s) 710, 715. The memory 720, 725 stores software 780 implementing one or more innovations described herein, in the form of computer-executable instructions suitable for execution by the processing unit(s) 710, 715.

A computing system 700 can have additional features. For example, the computing system 700 includes storage 740, one or more input devices 750, one or more output devices 760, and one or more communication connections 770, including input devices, output devices, and communication connections for interacting with a user. An interconnection mechanism (not shown) such as a bus, controller, or network interconnects the components of the computing system 700. Typically, operating system software (not shown) provides an operating environment for other software executing in the computing system 700, and coordinates activities of the components of the computing system 700.

The tangible storage 740 can be removable or non-removable, and includes magnetic disks, magnetic tapes or cassettes, CD-ROMs, DVDs, or any other medium which can be used to store information in a non-transitory way and which can be accessed within the computing system 700. The storage 740 stores instructions for the software 780 implementing one or more innovations described herein.

The input device(s) 750 can be an input device such as a keyboard, mouse, pen, or trackball, a voice input device, a scanning device, touch device (e.g., touchpad, display, or the like) or another device that provides input to the computing system 700. The output device(s) 760 can be a display, printer, speaker, CD-writer, or another device that provides output from the computing system 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example 19—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example 20—Example Cloud Computing Environment

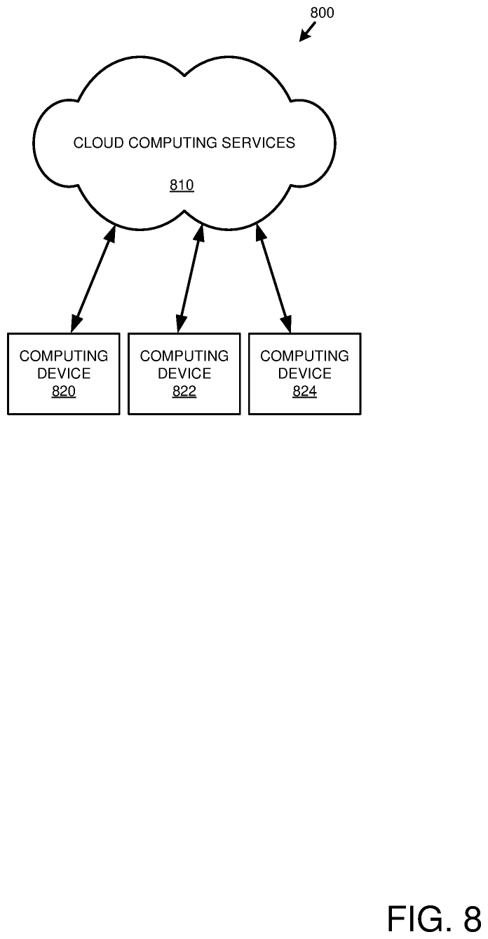

FIG. 8 depicts an example cloud computing environment 800 in which the described technologies can be implemented, including, e.g., the system 100 of FIG. 1 and other systems herein. The cloud computing environment 800 comprises cloud computing services 810. The cloud computing services 810 can comprise various types of cloud computing resources, such as computer servers, data storage repositories, networking resources, etc. The cloud computing services 810 can be centrally located (e.g., provided by a data center of a business or organization) or distributed (e.g., provided by various computing resources located at different locations, such as different data centers and/or located in different cities or countries).

The cloud computing services 810 are utilized by various types of computing devices (e.g., client computing devices), such as computing devices 820, 822, and 824. For example, the computing devices (e.g., 820, 822, and 824) can be computers (e.g., desktop or laptop computers), mobile devices (e.g., tablet computers or smart phones), or other types of computing devices. For example, the computing devices (e.g., 820, 822, and 824) can utilize the cloud computing services 810 to perform computing operations (e.g., data processing, data storage, and the like).

In practice, cloud-based, on-premises-based, or hybrid scenarios can be supported.

### Example 21—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 22—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving an indication of a request to publish a new code contribution to a code repository from a purported contributor, wherein the request comprises proposed source code;
extracting request metadata from the request;
determining a risk score for the new code contribution, wherein determining the risk score comprises submitting the extracted request metadata to a machine learning model trained with past metadata of the purported contributor;
determining a risk disposition of the request based on the risk score; and
processing the request according to the risk disposition.

2. The method of claim 1, wherein:
determining the risk disposition of the request comprises:
responsive to determining that the risk score exceeds a threshold, sending a notification to a security manager indicating that the new code contribution is determined to be risky;
receiving an appraisal response from the security manager; and
responsive to an approved appraisal response from the security manager, publishing the new code contribution.

3. The method of claim 2, wherein:
the new code contribution is blocked from being added to a source code repository until it is approved.

4. The method of claim 1, further comprising:
responsive to receiving a rejection appraisal from a security manager user interface, notifying the purported contributor that the request was rejected via a secondary channel.

5. The method of claim 1, wherein:
the machine learning model is trained with past metadata from across a plurality of code hosting platforms or projects.

6. The method of claim 1, wherein:
the machine learning model is trained to recognize atypical metadata for the purported contributor.

7. The method of claim 1, wherein:
the request metadata comprises an IP address of the purported contributor.

8. The method of claim 1, wherein:
the request metadata comprises a timestamp of the request to publish the new code contribution to the code repository.

9. The method of claim 1, wherein:
the request metadata comprises presence of commit artifacts of the request to publish the new code contribution to the code repository.

10. The method of claim 1, wherein:
the request metadata comprises a programming language of the new code contribution.

11. The method of claim 1, wherein:
the request metadata comprises a human language of the request to publish the new code contribution to the code repository.

12. The method of claim 1, wherein:
the request metadata comprises a number of files of the request to publish the new code contribution to the code repository.

13. The method of claim 1, wherein:
the request metadata comprises a size of the new code contribution.

14. The method of claim 1, wherein:
the request metadata comprises an amount of documentation of the request to publish the new code contribution to the code repository.

15. A computing system comprising:
at least one hardware processor;
at least one memory coupled to the at least one hardware processor;
a source code repository of published code contributions;
a machine learning model trained with request metadata of past observed requests to publish new code contributions to the source code repository to compute a risk score; and
one or more non-transitory computer-readable media having stored therein computer-executable instructions that, when executed by the computing system, cause the computing system to perform:
receiving a request to publish a new code contribution to the source code repository from a purported contributor, wherein the request comprises proposed source code and request metadata;
extracting the request metadata from the request;
determining a risk score for the new code contribution, wherein computing the risk score comprises submitting the request metadata to the machine learning model, wherein the machine learning model is trained with past metadata of the purported contributor;
determining a disposition of the request based on the risk score; and
processing the request according to the disposition.

16. The system of claim 15, further comprising:
a user interface configured to present a risk assessment alert to a security manager responsive to detecting that the risk score computed by the machine learning model for the request to publish the new code contribution exceeds a threshold.

17. The system of claim 16, wherein:
the threshold is configurable by the security manager.

18. The system of claim 15, wherein:
determining the disposition of the request comprises:
responsive to determining that the risk score exceeds a threshold, sending a notification to a security manager indicating that the new code contribution is determined to be risky;
receiving an appraisal response from the security manager; and
responsive to an approved appraisal response from the security manager, publishing the new code contribution.

19. The system of claim 15, wherein:
the machine learning model is trained to recognize atypical metadata for the purported contributor; and
the request metadata comprises:
an IP address of the purported contributor;
a timestamp of the request to publish the new code contribution to the source code repository;
a programming language of the new code contribution;
a human language of the request to publish the new code contribution to the source code repository; and
a size of the new code contribution.

20. One or more non-transitory computer-readable media comprising computer-executable instructions that, when executed by a computing system, cause the computing system to perform operations comprising:
receiving an indication of a request to publish a new code contribution to a source code repository from a purported contributor, wherein the request comprises proposed source code and request metadata;
extracting the request metadata from the request;
determining a risk score for the new code contribution, wherein computing the risk score comprises submitting the request metadata to a machine learning model trained with past metadata of the purported contributor;
determining a disposition of the request based on the risk score; and
processing the request according to the disposition;
wherein:
determining the disposition of the request comprises:
responsive to determining that the risk score exceeds a threshold, sending a notification to a security manager indicating that the new code contribution is determined to be risky;
receiving an appraisal response from the security manager; and
responsive to an approved appraisal response from the security manager, publishing the new code contribution; and
based on the risk score, the new code contribution is blocked from being added to the source code repository until the new code contribution is approved.
